(19) United States
(12) Patent Application Publication
(10) Pub. No.: US 2010/0300307 A1
(43) Pub. Date: Dec. 2, 2010

(54) High-Potency Juicer

(76) Inventor: Jin Yi Huang, Antin Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/640,126

(22) Filed: Dec. 17, 2009

(30) Foreign Application Priority Data
May 28, 2009 (CN) 200920057693.2

(51) Int. Cl. A23N 1/02

(52) U.S. Cl. 99/511

(57) ABSTRACT

A high-potency juicer is disclosed, having a base and a cutting tool turntable, where the base is made up of a body and a middle member joining the body thereon, and the middle member is provided with a cavity. The body is provided with a driving component. The cutting tool turntable is accommodated in the cavity and is rotated by the driving component, where a first filtering net is set up around the circumference of the cutting tool turntable. A first cutting tool is mounted on the ground part of the cutting tool turntable, and a second cutting tool is mounted on top of the first cutting tool, where the first cutting tool and the second cutting tool are joined by a second filtering net at their circumferences. On the one hand it is beneficial not only for the cutting tool turntable to mount more cutting tools but for simultaneous grinding, cutting and squeezing of the foods by a dual set of cutting tools, boosting the efficiency of juice extraction. On the other hand, the design of dual filtering nets substantially boosts the outcome of the filtering, which means that this invention features simple structure yet better practicality.

### BACKGROUND OF THE INVENTION

1. Field of the Invention

This invention relates generally to a juicer and more particularly to one featuring high potency.

2. Description of the Prior Art

As people's living standards have been greatly enhanced, consumers pursue quality life increasingly. A demand for the juicer is rising year by year, even the juicer was not a required household appliance traditionally. And that helps to transit mindset of consumers from a pure basic living necessity to a nutrition healthy taste, further giving rise to more attention to the juicer. Prior art juicers have a cutting tool turntable fixed in the base and driven by a motor. Once the foods to be extracted for juice are placed in the cutting tool turntable, the cutting tool of the cutting tool turntable then carries out grinding, cutting and squeezing of the foods. Meanwhile, the extracted juice is drawn outward by the centripetal force of the rotating cutting tool turntable, and the juice then passes the filtering nets around the cutting tool turntable, which fulfills the extraction of juice. The conventional cutting tool turntables have only single cutting tool, which is hard to satisfy the cutting needs as the cutting tool turntable rotates. It not only fails quite often to crush the foods into juice but always takes longer time of rotation for the juice, which diminishes the efficiency drastically and is unfavorable for the market promotion.

### SUMMARY OF THE INVENTION

In the light of the above drawbacks, this inventor conceived the idea for offering a potent juicer that is able to sufficiently make use of the space of the cutting tool turntable, for the mounting of more sets of cutting tools to lift the efficiency of the extraction of juice.

To realize the aforesaid objective, this invention takes the following techniques:

A high-potency juicer comprises a base and a cutting tool turntable, where the base is made up of a body and a middle member placing on top of the body and joining to each other, and the middle member is provided with a cavity while the body is provided with a driving component. The cutting tool turntable is accommodated in the cavity and is rotated by the driving component, where a first filtering net is set up at the circumference of the cutting tool turntable, and a first cutting tool is mounted on the ground part of said cutting tool turntable. A second cutting tool is mounted on top of the first cutting tool, and the first cutting tool and the second cutting tool are joined by a second filtering net at their circumferences.

The aforesaid ground part comprises a first footing and a second footing that mount each other, where the first footing is a mountable structure relative to the second footing, and the first cutting tool is mounted on the first footing.

The aforesaid second cutting tool is annular in shape, which is set up on the top edge of the second filtering net.

The aforesaid cavity is provided with a plurality of inclined ribs on its interior wall.

The advantages of this invention are as follows:

1.) Through the design of dual cutting tools located at top and bottom on the cutting tool turntable, it is beneficial not only for the cutting tool turntable to mount more cutting tools but for simultaneous grinding, cutting and squeezing of the foods, boosting the efficiency of juice extraction, which means that this invention features simple structure yet better practicality.

2.) Since the cutting tool turntable is provided with a first filtering net and a second filtering net, this design of dual filtering nets substantially boosts the outcome of the filtering.

3.) The ground part of the cutting tool turntable is a mountable structure, which is handy for the cleaning and replacement, substantially boosting the convenience of the use.

### BRIEF DESCRIPTION OF THE DRAWINGS

FIG. 1 is a schematic assembled view of the whole piece of this invention;

FIG. 2 is a schematic exploded view of the middle member and the cutting tool turntable of this invention;

FIG. 3 is a schematic external view of the cutting tool turntable of this invention;

FIG. 4 is a top view of FIG. 3; and

FIG. 5 is a sectional view of FIG. 4 viewing from A-A.

### DETAILED DESCRIPTION OF THE INVENTION

The following is a preferred exemplified embodiment accompanied with drawings which is targeted to give detailed description of this invention.

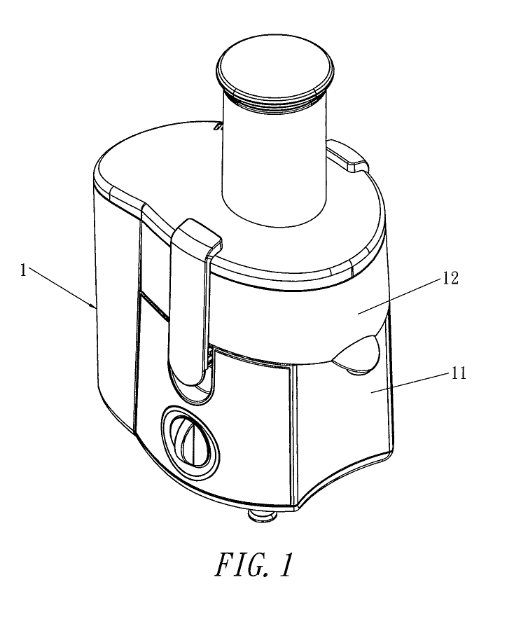

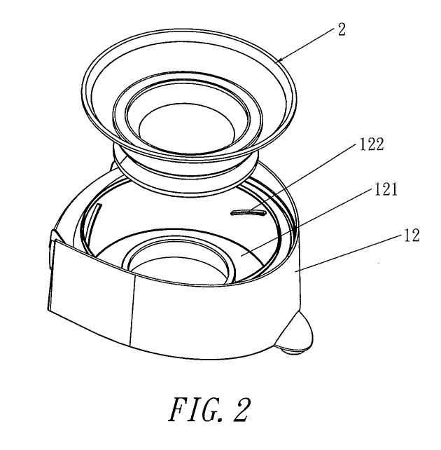

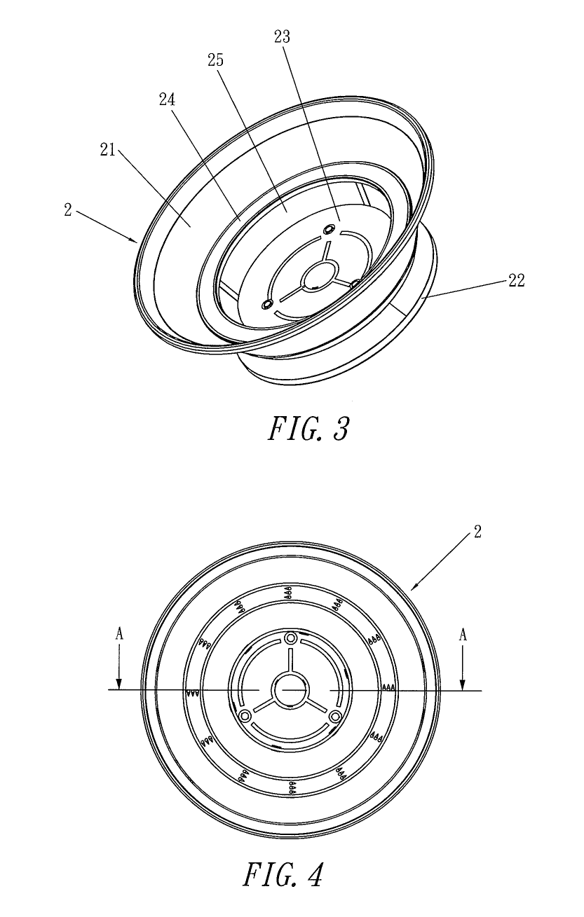

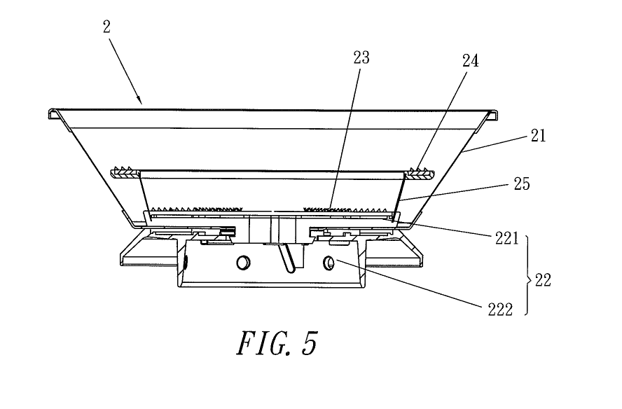

Referring to FIGS. 1˜5, a high-potency juicer comprises a base 1 and a cutting tool turntable 2, where the base 1 is made up of a body 11 and a middle member 12 joining the body 11 thereon, wherein:

The body 11 is provided with a driving component, where the driving component can be a motor; the aforesaid middle member 12 is provided with a cavity 121, and the cutting tool turntable 2 is accommodated in the cavity 121 and is rotated by the driving component. The mounting of the above portion can reference to the architecture of the conventional juicers, which won't be described herewith.

The key of this invention lies in the improvement of the cutting tool turntable 2, where a first filtering net 21 is set up around the cutting tool turntable 2; especially, a first cutting tool 23 and a second cutting tool 24 are mounted at top and bottom of the ground part 22 of the cutting tool turntable 2 respectively, and the second cutting tool 24 is mounted on top of the first cutting tool 23, where the first cutting tool 23 and the second cutting tool 24 are joined by a second filtering net 25 at their circumferences, which makes the second filtering net 25 to be located inner to the first filtering net 21, enabling a better filtering through the dual filters, the first filtering net 21 and the second filtering net 25. The aforesaid second cutting tool 24, annular in shape, is set up on the top edge of the second filtering net 25, and the second cutting tool 24 is able to be mounted with a sharp knife-edge, or with ribs for a squeeze, which is open for the selection herewith. The aforementioned ground part 22 comprises a first footing 221 and a second footing 222 that mount each other, where the first footing 221 is a mountable structure relative to the second footing 222, and the first cutting tool 23 is set up on the first footing 221. Accordingly, through the dismounting of the first footing 221, a handy way of cleaning and replacement can be achieved, which substantially boosts the convenience of the use.

During the high speed rotation of the cutting tool turntable 2, the first cutting tool 23 corresponds to the grinding, cutting and squeezing for the foods at the bottom portion, while the second cutting tool 24 to the effective grinding, cutting and squeezing for the foods floated due to the high speed rotation. Once the first cutting tool 23 and the second cutting tool 24 work simultaneously, the efficiency of the extraction of juice can be considerably boosted.

The cavity 121 of the middle member 12 is provided with a plurality of inclined ribs 122 on its interior wall, where the ribs 122 resist the upward flow generated by the rotation of the cutting tool turntable 2, which further pushes the flow downward to exert pressure on the extracted foods, lifting substantially the efficiency of the extraction of juice.

This invention features the design of dual cutting tools located at top and bottom in the cutting tool turntable and dual filtering nets, which is beneficial not only for the cutting tool turntable to mount more cutting tools but for simultaneous grinding, cutting and squeezing of the foods, boosting the efficiency of the extraction of juice. On the other hand, the design of dual filtering nets substantially boosts the outcome of the filtering, which means that this invention features simple structure yet better practicality.

Accordingly, the aforesaid is simply an exemplified embodiment of the present invention, which is not intended to limit the scope of the claim of this invention. Any equivalent embodiments or modifications without departing from the spirit and scope of the present invention are therefore intended to be embraced.

What is claimed is:

1. A high-potency juicer, having a base and a cutting tool turntable, where said base is made up of a body and a middle member joining the body thereon, and the middle member being provided with a cavity while the body is provided with a driving component, said cutting tool turntable being accommodated in the cavity and being rotated by the driving component, where a first filtering net is set up around the circumference of said cutting tool turntable, featuring: a first cutting tool being mounted on the ground part of said cutting tool turntable, and a second cutting tool being mounted thereon, where the first cutting tool and the second cutting tool are joined by a second filtering net at their circumferences.

2. A high-potency juicer as in claim 1, featuring: the ground part comprising a first footing and a second footing that both mount to each other, where the first footing is a mountable structure relative to the second footing, and the first cutting tool being set up on the first footing.

3. A high-potency juicer as in claim 1, featuring: the second cutting tool being annular in shape, and being set up on the top edge of the second filtering net.

4. A high-potency juicer as in claim 1, featuring: the cavity being provided with a plurality of inclined ribs on its interior wall.
